(19) United States
(12) Patent Application Publication
(10) Pub. No.: US 2020/0195602 A1
(43) Pub. Date: Jun. 18, 2020

(54) ONLINE SYSTEM AND METHOD FOR RECEIVING FEEDBACK REGARDING APPAREL OPTIONS VIA AN ONLINE COMMUNITY

(71) Applicant: Anthony Knopp, Thousand Oaks, CA (US)

(72) Inventor: Anthony Knopp, Thousand Oaks, CA (US)

(21) Appl. No.: 16/716,933

(22) Filed: Dec. 17, 2019

Related U.S. Application Data
(60) Provisional application No. 62/780,962, filed on Dec. 18, 2018.

(51) Int. Cl. H04L 12/58; G06F 16/9536; G06F 16/9535; G06Q 30/06; G06Q 30/02; G06F 16/9538

(52) U.S. Cl. CPC H04L 51/32; G06F 16/9536; H04L 51/10; G06F 16/9535; G06F 16/9538; G06Q 30/0631; G06Q 30/0208; G06Q 30/0231; G06Q 30/0627

(57) ABSTRACT

An online method for receiving feedback from an online community of a curated marketplace regarding apparel options is provided. The online method and system for its use includes transmitting a plurality of photos of different apparel options from a first computing device directly or indirectly to at least one second computing device and receiving the plurality of photos at the at least one second computing device. A user selection of one of the plurality of photos is facilitated via the at least one second computing device and transmitted from the at least one second computing device to the first computing device to aid a user in selecting apparel.

### CROSS-REFERENCE TO RELATED APPLICATION

This U.S. Patent Application claims priority to U.S. Provisional Application: Application Ser. No. 62/780962 filed Dec. 18, 2018, the disclosure of which is considered part of the disclosure of this application and is hereby incorporated by reference in its entirety.

### FEDERALLY SPONSORED RESEARCH OR DEVELOPMENT

Not Applicable

### SEQUENCE LISTING, A TABLE, OR A COMPUTER PROGRAM

Not Applicable

### FIELD OF THE INVENTION

The present disclosure relates generally to an online system and method for providing apparel options and, more particularly, to facilitating feedback from a curated online community regarding the apparel options to generally aid a user of the system and method in the selection of a given apparel option.

### BACKGROUND

Many individuals struggle with what to wear to various functions or events. For example, people may have a difficult time selecting what to wear to a formal party, a social gathering with friends, a wedding, a work party, interview, or various other events.

In a typical scenario, these individuals will often resort to trying on several outfits and combinations of outfits and seek approval from close friends, relatives, family members, or peers. Typically, this process can be stressful and time consuming. Further, the feedback provided to the individual may not be helpful or genuine as the approval may not be honest or from a non-biased individual. Still further, the individual may want o seek approval for an event in a different geographic area with different style norms, climate, region, peer group, occupation, gender, or other alternate group with differing style norms.

Therefore, there exists a need within the market for a system and method that aids a user in the approval, disapproval, and acknowledgement of a given fashion choice. Preferably this system and method is facilitated through online communication within a network and utilizes a curated market of more than community member designated to provide feedback.

### SUMMARY OF THE INVENTION

In one aspect, an online method for receiving feedback from a curated online community regarding apparel is provided. The online method includes transmitting a plurality of photos of different apparel options from a first computing device directly or indirectly to at least one second computing device. A user selection of one of the plurality of photos is facilitated via the at least one second computing device and transmitted from the at least one second computing device to the first computing device. The user selection may alternately include a ranking system, wherein the user ranks each photo of the plurality of photos via the at least one second computing device to the first computing device.

The system and method of the present disclosure is most generally intended to function as a curated marketplace hosted online through a network and a plurality of coupled devices to allow a user to seek feedback on various fashion choices from selected members of the curated marketplace. Accordingly, a user will utilize photos of a plurality of fashion choices, or outfits, and solicit feedback from additional users on the network. The curated marketplace allows a user to select other users from a preselected group who may have specific experience, knowledge, or information related to particular event, region, geographic area, occupation, culture, industry, sector etc.

For example, a user of the system and method located in New York may wish to interview for a position within the technology sector in San Francisco. In preparation for the interview, the user, located in New York, may wish to receive feedback on a plurality of outfits from other users of the system who are or have been employed in the technology sector and located in San Francisco to ensure that the outfits conform to the usual style norms for an interview located in San Francisco. Accordingly, the user would take photographs of the plurality of outfits and seek feedback from the curated marketplace of users within the technology sector in San Francisco and use this feedback to select their preferred outfit. This allows the user to ensure that they have selected an outfit that is in accordance with these style norms and provides reassurance and confidence that the given outfit will be received positively. As can be seen from this exemplary hypothetical, this scenario can be extrapolated to any number of events, occasions, and situations.

The invention now will be described more fully hereinafter with reference to the accompanying drawings, which are intended to be read in conjunction with both this summary, the detailed description and any preferred and/or particular embodiments specifically discussed or otherwise disclosed. This invention may, however, be embodied in many different forms and should not be construed as limited to the embodiments set forth herein; rather, these embodiments are provided by way of illustration only and so that this disclosure will be thorough, complete and will fully convey the full scope of the invention to those skilled in the art.

### BRIEF DESCRIPTION OF THE DRAWINGS

FIG. 1 is a block diagram of an exemplary system for receiving feedback from an online community regarding apparel options, according to the present disclosure;

FIG. 2 is an exemplary screen display representing a user interface for inputting user profile information into the system of FIG. 1, according to the present disclosure; and

FIG. 3 is a flow diagram representing a first exemplary method for receiving feedback from an online community regarding apparel and accessory options, according to the present disclosure.

### DETAILED DESCRIPTION

The following detailed description includes references to the accompanying drawings, which forms a part of the detailed description. The drawings show, by way of illustration, specific embodiments in which the invention may be practiced. These embodiments, which are also referred to herein as “examples,” are described in enough detail to enable those skilled in the art to practice the invention. The embodiments may be combined, other embodiments may be utilized, or structural, and logical changes may be made without departing from the scope of the present invention. The following detailed description is, therefore, not to be taken in a limiting sense.

Before the present invention of this disclosure is described in such detail, however, it is to be understood that this invention is not limited to particular variations set forth and may, of course, vary. Various changes may be made to the invention described and equivalents may be substituted without departing from the true spirit and scope of the invention. In addition, many modifications may be made to adapt a particular situation, material, composition of matter, process, process act(s) or step(s), to the objective(s), spirit or scope of the present invention. All such modifications are intended to be within the scope of the disclosure made herein.

Unless otherwise indicated, the words and phrases presented in this document have their ordinary meanings to one of skill in the art. Such ordinary meanings can be obtained by reference to their use in the art and by reference to general and scientific dictionaries.

References in the specification to “one embodiment” indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in in the art to affect such feature, structure, or characteristic in connection with other embodiments whether or not explicitly described.

The following explanations of certain terms are meant to be illustrative rather than exhaustive. These terms have their ordinary meanings given by usage in the art and in addition include the following explanations.

As used herein, the term “and/or” refers to any one of the items, any combination of the items, or all of the items with which this term is associated.

As used herein, the singular forms “a,” “an,” and “the” include plural reference unless the context clearly dictates otherwise.

As used herein, the terms “include,” “for example,” “such as,” and the like are used illustratively and are not intended to limit the present invention.

As used herein, the terms “preferred” and “preferably” refer to embodiments of the invention that may afford certain benefits, under certain circumstances. However, other embodiments may also be preferred, under the same or other circumstances.

Furthermore, the recitation of one or more preferred embodiments does not imply that other embodiments are not useful and is not intended to exclude other embodiments from the scope of the invention.

As used herein, the term “coupled” means the joining of two members directly or indirectly to one another. Such joining may be stationary in nature or movable in nature. Such joining may be achieved with the two members or the two members and any additional intermediate members being integrally formed as a single unitary body with one another or with the two members or the two members and any additional intermediate members being attached to one another. Such joining may be permanent in nature or alternatively may be removable or releasable in nature. Similarly, coupled can refer to a two member or elements being in communicatively coupled, wherein the two elements may be electronically, through various means, such as a metallic wire, wireless network, optical fiber, or other medium and methods.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element without departing from the teachings of the disclosure.

Reference will now be made in detail to specific embodiments or features, examples of which are illustrated in the accompanying drawings. Wherever possible, corresponding or similar reference numerals will be used throughout the disclosure and accompanying drawings to refer to the same or corresponding parts.

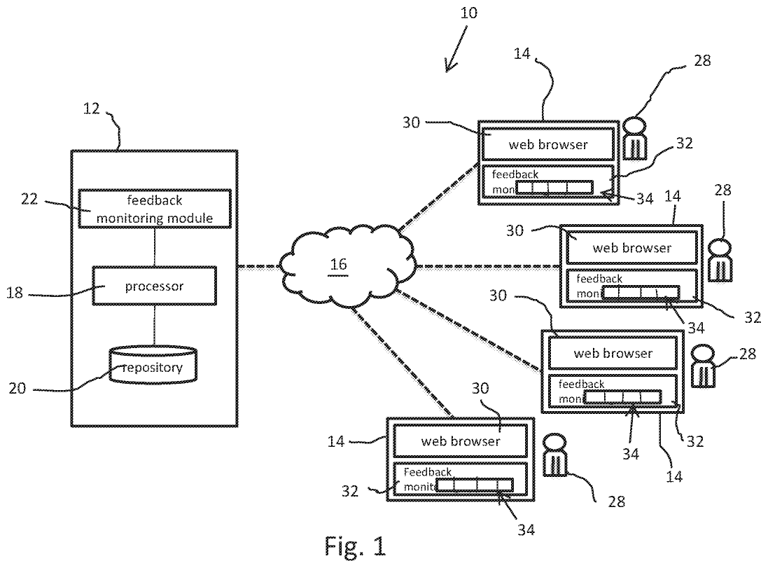

Referring now to FIGS. 1-3, the system 10 may generally include a server 12, or server system, and a plurality of user devices 14, or client devices or systems, coupled to communicate through a network 16 and/or coupled through communication links that allow information to be exchanged using conventional communication protocols and/or data port interfaces. That is, the server 12 and user devices 14 may communicate, or receive and transmit data, through the network 16 with each other using wired and/or wireless communication schemes. The network 16 may include a local area network, a wide area network, an intranet, and/or the Internet, for example. Although the system 10 is shown communicating through a single network 16, it should be appreciated that multiple networks may be utilized to facilitate direct and/or indirect electronic communication between the server 12 and one or more of the user devices 14.

The server 12, or set of servers, may include one or more computers having one or more processors, such as processor 18, memory, storage, a display, a network interface, and an input/output device, for example. The processor 18, or processors, may execute unique sets of instructions, which may be implemented as computer readable program code, stored in memory or storage, such that the server 12, or server system, is configured as a special purpose system. In particular, hardware, software, and particular sets of instructions transform the server 12 into the online system and method for receiving feedback regarding apparel options via an online community within a curated market.

The system 10 may include a database management system including one or more databases, such as data repository 20. The data repository 20 may store data useful in carrying out the strategies disclosed herein. Although the data repository 20 is illustrated as a component within the server 12, it should be appreciated that the server 12, or server system, may include any number of separate components or systems, including separate database(s), configured to communicate with one another in a manner consistent with the teachings disclosed herein.

The system 10 or, more specifically, the server 12, or server system, may include one or more modules useful in carrying out the strategies disclosed herein. In particular, the server 12 may include or utilize functionality expressed with reference to at least a feedback monitoring module 22. Additionally, and/or alternatively, for example, the server 12 may also include an account registration module, a ranking module, and a user manager module, etc.

It should be appreciated that the use of the term “modules” is for ease of explanation, rather than limitation, and is intended to represent certain related aspects or functionality of the system 10. That is, the feedback monitoring module 22 may represent processes for performing specific tasks, which may include a set of computer instructions, or computer readable program code, processed for performing specific tasks of the feedback monitoring module 22.

The feedback monitoring module 22, and/or other modules, which will be discussed in greater detail below, may facilitate the creation of accounts and/or users within the system 10. For example, a registration module may be used to collect data input by users 28 accessing the system 10 through the various user devices 14. According to some embodiments, the various user devices 14 may include any suitable electronic communication devices and/or workstations, such as, for example, personal computers, laptop computers, netbook computers, mobile devices, cell phones, smart phones, tablet devices, and wearable wireless devices. An account registration, or other, module may be used to collect various information, including, for example, personally identifiable information, such as, for example, name, address, and phone number, and billing, or payment, information for one or more services selected for purchase.

The feedback monitoring module 22 configured facilitate the sharing of photos of users 28 apparel options across the network 16 and between users 28 to provide feedback to the user 28 for the selection of a preferred apparel option.

A user manager module, or other module, may include and/or implement rules pertaining to the various users 28, or user types, of the system 10. For example, when one of the users 28 registers for one of the services of the feedback monitoring module 22, a user profile including user credentials, such as a username and password, may be created for the user 28 and stored in the data repository 20. The user manager module may be configured to ensure that each user 28, as identified using the unique credentials, is provided with appropriate access and capabilities with regard to the system 10.

According to an exemplary embodiment, one of the users 28 may access and register with the system 10 using any device or terminal capable of interfacing with the server 12. For example, one of the users 28 may register with the user device 14 having web-browsing abilities 30, such as, for example, a personal computer or a web-enhanced smart device. It should be appreciated that each of the user devices 14 referenced herein may include a processor, memory, storage, a display, a network interface, and an input/device, for example. According to web-enhanced devices, the user device 14 may communicate, or transfer and receive data, with the server 12, or feedback monitoring module 22, using, for example, Internet communication streams, such as an HTTP/HTTPS stream or other protocol stream, such as SMTP or SMS. Each user device 14 may also have a feedback monitoring app 32 installed therein for facilitating the functionality described herein. That is, the feedback monitoring app 32 may be configured to store a plurality of photos 34 in a coupling with the feedback monitoring module 22.

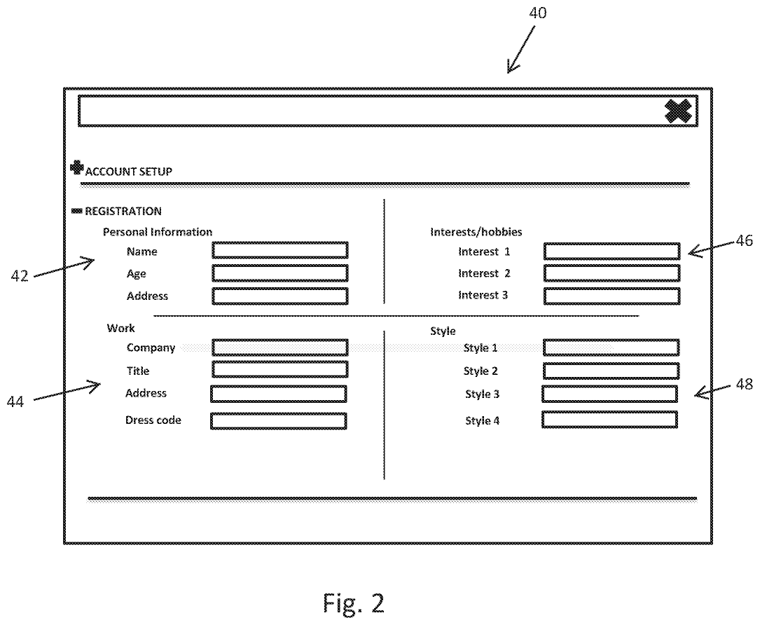

An exemplary display screen provided through a user interface of the user device 14 of one of the users 28 during registration is shown at 40 in FIG. 2. Although the display screen 40 only depicts a portion of the information that might be collected during a registration process, FIG. 2 is provided to detail some relevant information that may be used by the system 10. For example, the interested party user 28 registering for one or more of the services of the system 10 may be prompted to enter information such as, but not limited to, for example, personal information 42, work information 44, interests and hobbies information 46, and style information 48. This collected information (42, 46, 44, 48) may be utilized by the feedback monitoring module 22 to develop a curated marketplace, wherein the collected information is utilized by the interested party user 28 to select feedback from a specific group of party users 28 to facilitate honest and relevant feedback.

The system 10 may include a ranking module, the ranking module coupled to the feedback monitoring app 32, feedback monitoring module 22, and plurality of photos 34 allowing the user 28 of the system to rank a given photo of the plurality of photos 34. The ranking module may provide a calculation to a given rank of the plurality of photos 34 to enable easier selection of a given photo by the user 28, wherein multiple user 28 rankings are aggregated to provide the best or most like photo of the plurality of photos 34 to aid in selection of a given outfit.

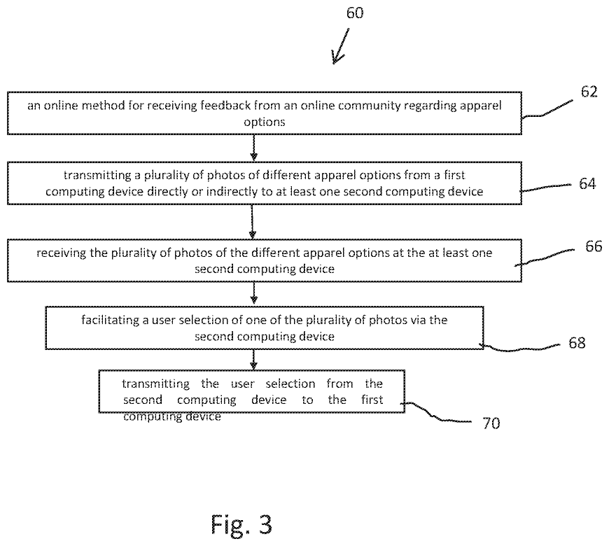

Turning now to FIG. 3, and referring also to previous FIGS. 1 and 2, there is a shown a logic flow diagram representing an exemplary method 60 for receiving feedback from a curated online community regarding the selection of a plurality of apparel options. All or portions of the method 60 may be facilitated and/or implemented using the system 10 of the present disclosure. According to a specific example, some of the steps implementing the disclosed method 60 may be in the form of computer readable program code stored in the data repository 20 of the system 10 and executed by the processor 18, or other computer usable medium. The method 60 may run continuously or may be initiated in response to one or more predetermined events.

The method 60 begins at a START. From the START, the method 60 proceeds to Box 62, which includes providing or receiving feedback from a curated online community regarding a plurality of apparel options. At Box 64, a plurality of photos 34 of different apparel options are transmitted from a first computing device, such as one of first computing devices 14, directly or indirectly to at least one second computing device, which may include one of the computing devices 14.

At Box 66, the plurality of photos 34 of one of the user devices 14 are received at at least one of the other user devices 14. A user selection of one of the plurality of photos 34 is facilitated via the second computing device 14, at box 68. The user selection is then transmitted from the second computing device 14 to the first computing device 14, at Box 70.

The system 10 and method steps 60 of the present disclosure provides the user 28 the ability to post their apparel and/or accessory options for a particular event, etc. for other users 28 they have selected within the curated marketplace through use of predetermined categories (e.g., friends, including peer groups, colleagues, family, celebrities, etc.). The selected participants or users 28 that receive the plurality of photos 34 of the apparel and/or accessory options may select one of the options or rank the options and send the selected option to the user 28 to aid in decision making.

According to an exemplary embodiment, the user 28 may identify the event to be attended, post a predetermined number of options for apparel and/or accessories, select a predetermined set of curated users to review the options through viewing the plurality of photos 34, and receive the preferred and selected options from the other identified users 28 in a collaborative process.

The system 10 and method 60 for use may also provide the availability for users 28 to participate in the method 60 by providing feedback to other users 28 of the system 10. For example, in an exemplary embodiment, users 28 may earn points for participating by giving feedback to others. Further, the system 10 and method 60 may enable participation by retailers through linking to provide users 28 options for purchase, sales, incentives, and participation in the disclosed system and method.

While the invention has been described above in terms of specific embodiments, it is to be understood that the invention is not limited to these disclosed embodiments. Upon reading the teachings of this disclosure many modifications and other embodiments of the invention will come to mind of those skilled in the art to which this invention pertains, and which are intended to be and are covered by both this disclosure and the appended claims. It is indeed intended that the scope of the invention should be determined by proper interpretation and construction of the appended claims and their legal equivalents, as understood by those of skill in the art relying upon the disclosure in this specification and the attached drawings.

### LIST OF ELEMENTS

10 system

12 server

14 user devices

16 network

18 processor

20 data repository

22 feedback monitoring module

28 users

30 web browser

32 feedback monitoring app

34 plurality of photos

40 display screen

42 personal information

44 work information

46 interests and hobbies information

48 style information

60 flow diagram

62 an online method for receiving feedback from an online community regarding apparel options

64 transmitting a plurality of photos of different apparel options from a first computing device directly or indirectly to at least one second computing device

66 receiving the plurality of photos of the different apparel options at the at least one second computing device

68 facilitating a user selection of one of the plurality of photos via the second computing device

70 transmitting the user selection from the second computing device to the first computing device

What is claimed is:

1. A system enabling feedback from a curated marketplace regarding apparel options, the system comprising:
a network
a server, the server comprising:
a feedback monitoring module; and
a plurality of user devices coupled to the server through the network.

2. The system as in claim 1, wherein the server further comprises:
a processor; and
a data repository.

3. The system as in claim 1, wherein the plurality of user devices further comprises:
a feedback monitoring app coupled to the feedback monitoring module and configured to store a plurality of photos.

4. The system as in claim 1, wherein the feedback monitoring module collects personal information of a user for use in forming the curated marketplace.

5. An online system and method for use in enabling feedback from a curated marketplace regarding apparel options, the system comprising:
a network
a server, the server comprising:
a feedback monitoring module;
a processor;
a data repository; and
a plurality of user devices coupled to the server through the network.

6. The system as in claim 5, wherein the plurality of user devices further comprises:
a feedback monitoring app coupled to the feedback monitoring module and configured to store a plurality of photos.

7. The system as in claim 6, wherein the feedback monitoring module collects personal information of a user for use in forming the curated marketplace.

8. The system as in claim 6, wherein the system comprises more than one network.

9. The system as in claim 6, wherein the system comprises a registration module.

10. The system as in claim 6, wherein the system comprises a ranking module.

11. The system as in claim 6, wherein the plurality of user devices include a web browser for coupling to the server.

12. The system as in claim 10, wherein the ranking module is configured to aggregate a selection of the plurality of photos to determine a most selected photo of the plurality of phots.

13. An online method for receiving feedback from an online community in the form of a curated marketplace regarding apparel options, the method comprising:
transmitting a plurality of photos of different apparel options from a first computing device directly or indirectly to at least one second computing device;
receiving the plurality of photos at the at least one second computing device;
facilitating a user selection of one of the plurality of photos via the at least one second computing device; and
transmitting the user selection from the at least one second computing device to the first computing device.

14. An online method as in claim 13, wherein the method further comprises:
facilitating a user selection of the plurality of photos in a ranked order via the at least one second computing device;
calculating the most frequently selected photo from the plurality of photos; and
transmitting the most frequently selected photo to the first computing device.
